(19) United States
(12) Patent Application Publication
(10) Pub. No.: US 2020/0061400 A1
(43) Pub. Date: Feb. 27, 2020

(54) DEVICE FOR MEASURING THE LEAKAGE RATE OF AT LEAST ONE ELEMENT OF A PROTECTIVE BREATHING MASK

(71) Applicant: ETAT FRANÇAIS REPRÉ PAR LE DÉLÉGUÉ GÉNÉRAL POUR L' ARMEMENT, Paris Cedex 15 (FR)

(72) Inventor: Benoît CHANDESRIS, Orsay (FR)

(21) Appl. No.: 16/489,060

(22) PCT Filed: Feb. 23, 2018
(86) PCT No.: PCT/FR2018/000036

§ 371 Date: Aug. 27, 2019

(30) Foreign Application Priority Data
Feb. 28, 2017 (FR) 1700198

(51) Int. Cl. A62B 27/00; G01M 3/32

(52) U.S. Cl. CPC A62B 27/00; G01M 3/3218; A62B 18/10; G01M 3/3263; G01M 3/3209; G01M 3/3254

(57) ABSTRACT

Disclosed is a device for measuring the leakage rate of at least part of a protective breathing mask, the mask having at least one communication orifice between the interior, by way of an inlet, and the exterior, by way of an outlet. The communication orifice has an open position, in which a fluid can pass through the orifice between the inlet and outlet, and a closed position, preventing fluid passage through the orifice. The measurement device includes: a mechanism generating a pressure differential between the interior and exterior of the mask; a monitoring unit for the pressure generator; a unit measuring leakage of the communication orifice, in the closed position, at the level of the inlet and outlet, respectively; and a unit by which the pressure generator is fixed near the communication orifice.

### BACKGROUND OF THE INVENTION

### Field of the Invention

The present invention relates to the technical field of devices for measuring the leakage rate of at least one element of a protective breathing mask, the protective breathing mask having at least one communication orifice between the interior of the mask, by way of an inlet, and the exterior of the mask, by way of an outlet, the communication orifice having an open position, in which a fluid can pass through the orifice between the inlet and the outlet, and a closed position, in which a fluid cannot pass through the orifice.

### Description of the Related Art

A protective breathing mask, whether it involves a half-mask or a full mask, makes it possible to protect the wearer from particles (aerosols) or gas by filtering the air intended for the wearer of the mask through a filtration device. Except for the simplest masks, the exhalation of the wearer is done through an exhalation valve. Thus, the exhaled air does not pass back through the filtering layers. As a result, if the exhalation valve fails, a significant leak is created and the protection provided to the wearer by his mask is deteriorated, generally significantly.

More broadly, the leaks in the protective mask can come from three sources:
Gas or aerosol not filtered by the filtering masses of the mask (filtering cartridge, etc.);
Leaks at the interface between the mask and the wearer's face;
Leak at the accessories of the mask, for example at the exhalation valve.

The overall protection provided by the mask can be tested in different ways:
Qualifying tests with an odorous gas. If the wearer of the mask smells this odorous gas, then the protection is not sufficient. The protection guaranteed by this test is very weak, and largely insufficient in the case of a CBRN event;
Quantitative test on a wearer equipped with his mask, in a booth in which an aerosol is generated, for example NaCl (see standard NF EN 136) or cigarette smoke, with a system calculating the protection factor with respect to this aerosol using the ratio of the concentration outside the mask to the concentration inside the mask;
Quantitative test of a wearer equipped with his mask, in a booth in which a non-toxic gas is generated, for example SF₆, with a system calculating the protection factor with respect to this gas (see standard NF EN 136).

These tests, which are technically complex and long to implement, are often not able to be carried out without expensive devices.

Furthermore, the mask tests described above generally do not make it possible to discriminate between a leak at the interface between the mask and the face, due for example to a poor mask choice given the morphology of the wearer, or to a poor strap adjustment, on the one hand, and a leak at an accessory of the defective mask, for example the exhalation valve, on the other hand.

In order to guarantee the safety of military personnel in a CBRN atmosphere, an effort has thus been made to determine whether the mask itself has an acceptable performance level. A system used by some users is meant to make it possible to test the accessories of the mask, by positioning the mask on a fake inflatable head, and creating a vacuum inside the mask. Maintaining this vacuum makes it possible to raise the leakage rate. However, in such a system, stray leaks may sometimes occur at the mask/inflatable head interface.

To the best of our knowledge, no specific test exists for the exhalation valve. Qualitative tests can be done on the valves (weights, measurements) to verify the compliance with technical specifications, but there is a need to quantify the inherent performance of the valve during operation and for a specific testing system for exhalation valves.

### SUMMARY OF THE INVENTION

According to the invention, a device for measuring the leakage rate of at least one element of a protective breathing mask, the protective breathing mask having at least one communication orifice between the interior of the mask, by way of an inlet, and the exterior of the mask, by way of an outlet, the communication orifice having an open position, in which a fluid can pass through the orifice between the inlet and the outlet, and a closed position, in which a fluid cannot pass through the orifice, is characterized in that it comprises:
a means for generating a pressure differential between the interior and the exterior of the mask,
a means for monitoring the means for generating a pressure differential between the interior and the exterior of the mask,
a measuring means for measuring the leakage rate of the communication orifice, in the closed position, at the level of the inlet and outlet, respectively,
a means for attaching near the communication orifice the means for generating a pressure differential between the interior and the exterior of the mask.

Advantageously, the means for generating a pressure differential is a means for generating an overpressure at the exterior of the mask, the pressure at the outlet of the communication orifice being greater than the pressure at the inlet of the communication orifice, the measuring means being able to measure the leakage rate of the communication orifice, in the closed position, at the outlet, outside the mask.

The communication orifice can be an exhalation valve, a phonic membrane, a device for consuming liquid food products or any other accessory of the mask allowing a communication between the interior and the exterior of the mask.

Advantageously, the overpressure, respectively vacuum, generating means, is an electric pump.

The measuring means can include a flow meter for measuring the overall volume that is injected into the volume confined above the communication orifice such as a valve, in the zone corresponding to the interior of the mask in the case of work with creation of an overpressure, in order to maintain a constant overpressure (/vacuum).

The measuring means can include a differential pressure gauge making it possible to determine the overpressure (/vacuum) applied on the communication orifice such as a valve. The evolution of the overpressure (/vacuum) over time after stopping the overpressure (respectively vacuum) generating means can serve to determine the leakage rate, in addition to or in place of a flow meter.

The device according to the invention is based on the measurement of the leakage rate through a valve. This leakage rate makes it possible to quantify the inherent performance of the valve. At the same time, this invention can be adapted to the measurement of the performance of civilian mask exhalation valves, other accessories of the mask, etc. In a known manner, the invention must make it possible to test the accessories including a communication orifice directly on the mask, in order to validate its performance in situ. Indeed, placing or removing accessory, for example a valve, on its holder can cause significant damage.

The idea is therefore to connect directly to the perimeter of the valve, in the case of testing a valve, and to apply a pressure differential representative of the pressure in the mask when a wearer breathes. The leakage rate is thus that of the valve alone, or of the accessory having a tested communication orifice of the mask, while eliminating stray leaks at the mask/head interface.

The device according to the invention therefore includes an element of the clip type allowing securing with the mask having the device to be tested, or with a holder on which the device to be tested is mounted.

Advantageously, the means for attaching the vacuum, respectively overpressure, generating means includes a clip body able to be secured to a holder of the communication orifice.

A piston can be mounted sliding on the body, a spring being compressed between the body and the piston.

The body can include a lip, able to cooperate with a slot provided in the holder.

The piston can include a channel connected to the overpressure, respectively vacuum, generating means.

### BRIEF DESCRIPTION OF THE DRAWINGS

Other features and advantages of the invention will appear in the following description of one preferred embodiment with reference to the appended drawings, but which is in no way limiting.

FIG. 1 is a schematic illustration showing an attaching means according to the invention, made up of a clip-type element, engaged on a holder belonging to a mask and bearing a valve,

FIG. 2 is a schematic perspective view of the attaching means of FIG. 1,

FIG. 3 is a top half-view of the attaching means of FIG. 1, the holder not being shown, and

FIG. 4 is a side elevation half-view of the attaching means of FIG. 1, the holder not being shown.

### DESCRIPTION OF THE PREFERRED EMBODIMENTS

We will now more particularly describe the structure of a device for measuring the leakage rate according to the invention.

The device according to this embodiment includes:
an air intake in overpressure, typically in the case of a test bench, or then an integrated overpressure generating system, for example via a small pump, in the case of a portable variant;
a valve system controllable to allow or not allow an air flow to pass, depending on a setpoint;
a flow meter to measure the overall volume that is injected into the volume confined above the valve to maintain a constant overpressure;
a connector making it possible to have the air arrive above the valve, outside the mask, tightly, in situ on the mask;
a differential pressure gauge making it possible to determine the overpressure applied on the valve that will be used as means for monitoring the overpressure generating means;
a control-command electronic board, which, in this embodiment, is a module of the Arduino type, to control the controllable valve based on values measured by the differential pressure gauge, in order to keep a constant overpressure. This board also makes it possible to collect the information from the flow meter in order to calculate the volume injected during a test.

Optionally, a computer can be used to adjust the parameters of the system, such as the setpoint pressure, and to serve as man-machine interface. Without a computer, alternatively, a small screen or lighted or sound indicators can be connected to the control-command board, to save in terms of compactness.

The controllable valve assembly associated with a flow meter can be replaced by a flow regulator according to an alternative embodiment. The controllable valve assembly associated with a flow meter can be omitted, in an alternative embodiment.

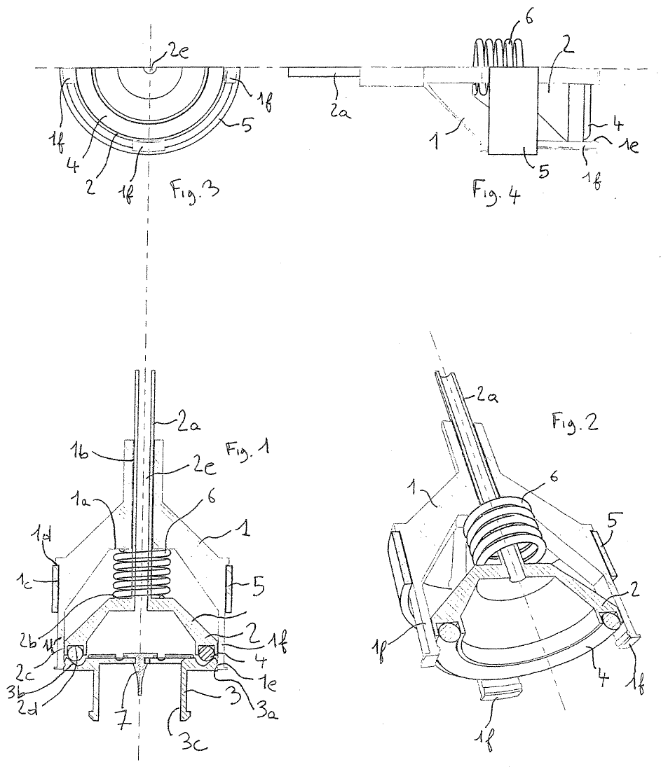

FIGS. 1 to 4 show an embodiment of an attaching means for the vacuum generating means type. The attaching is done by clipping a clip P in the groove 3a on the perimeter of a valve holder 3 and compressing an O-ring 4 around the valve 7, without touching the valve 7.

The clip P includes a body 1 with a shape substantially of revolution having a first end pierced with an orifice 1b in which the rod 2a of the piston 2 slides. The piston 2 also includes a head below which a bearing surface 2b is located across from a bearing surface 1a belonging to the body 1. A spring 6 is inserted between the bearing surfaces 1a and 2b.

The head of the piston 2 also includes a lateral guiding surface 2c in contact with an interior cylindrical surface at a second end of the body 1, making it possible to guide the translation of the piston 2 by means of the body 1.

The head of the piston 2 lastly includes a cylindrical slot 2d accommodating an O-ring 4 ensuring the tightness with a contact zone 3b provided on the holder 3.

The piston 2 is also passed through by a longitudinal channel 2e, connected to the overpressure generator, thus making it possible to communicate an overpressure to the valve 7 mounted on the holder 3.

The part of the body 1 in contact with the contact surface 2c of the piston 2 has a small thickness and wide recesses only allowing deformable tongues 1f to remain. At the end of the body 1, a protruding lip 1e is able to engage in a slot 3a provided on the holder 3. In this way, a force exerted longitudinally on the body 1 will allow the deformation of the end of the body 1 and its engagement around the holder 3. The lip 1e, by penetrating the slot 3a, allows the clipping and the securing of the body 1 on the holder 3.

A ring 5, sliding on the outside of the body, can be moved across from the lip 1e so as to prevent the deformation of the body 1 and thus to ensure the attaching of the body 1 on the holder 3. The holder 3 has a communication orifice 3c allowing the wearer of the mask to exhale through the valve 7.

Most of the protective breathing masks have a valve with a slot 3a usable by the device according to the invention. In the case where such a slot is absent, it is also possible to consider attaching by clipping, in particular for example by replacing the lip 1e with a slot containing a deformable gasket.

In the case of a laboratory, on a test bench, the air to be injected, which can optionally be replaced by nitrogen or any other inert gas, can come from the compressed air network.

The device according to the invention has many advantages. It in particular makes it possible to test the inherent performance of the exhalation valve. The performance and the precision of the device indeed make it possible to discriminate the defective valves.

It is possible to test valves outside the mask or in situ on the mask.

From this perspective, it is possible to miniaturize the device and make it autonomous in particular using power from cells or batteries, without needing a compressed air network.

In this embodiment, a portable version of the device according to the invention weighs less than a kilo and has a volume of less than a liter.

In this case, the overpressure can be provided via a small pump, powered either from the electric grid, or from a battery, which gives the overall device the advantage, aside from being lightweight and small, of being self-sufficient in terms of energy. Such a compact device can be used directly by the user of the mask to check the proper working of its valve, whether completely in situ, the valve being in place in the mask or the valve being outside the mask, simply placed on a valve holder identical or similar to that of the mask.

Furthermore, it is possible to test other accessories of the mask, for example a phonic membrane, with a connector adapted to these accessories.

A same apparatus, irrespective of its version, can also be capable of measuring the leakage rates through the different accessories of the mask, either with the same number of lines as there are accessories of the mask, or with fewer lines but a measurement of the sum of the leakage rates through several accessories of the mask.

Lastly, until now we have described the option of connecting to the perimeter of the valve on the outer side of the mask and generating a controlled overpressure. However, it is also possible to connect to the perimeter of the valve on the inner side of the mass, and to create a controlled vacuum, which is equivalent.

1-9. (canceled)

10. A device for measuring the leakage rate of at least one element of a protective breathing mask, the protective breathing mask having at least one communication orifice between the interior of the mask, by way of an inlet, and the exterior of the mask, by way of an outlet, the communication orifice having an open position, in which a fluid can pass through the orifice between the inlet and the outlet, and a closed position, in which a fluid cannot pass through the orifice, the device comprising:
a means for generating a pressure differential between the interior and the exterior of the mask,
a means for monitoring the means for generating a pressure differential between the interior and the exterior of the mask,
a measuring means for measuring the leakage rate of the communication orifice, in the closed position, at the level of the inlet and outlet, respectively,
a means for attaching near the communication orifice the means for generating a pressure differential, the means for attaching the means for generating a pressure differential including a clamp body able to be secured to a holder of the communication orifice.

11. The device according to claim 10, wherein the means for generating a pressure differential is a means for generating a vacuum.

12. The device according to claim 10, wherein the means for generating a pressure differential is a means for generating an overpressure.

13. The device according to claim 12, wherein the means for generating an overpressure is a means for generating an overpressure at the exterior of the mask, the pressure at the outlet of the communication orifice being greater than the pressure at the inlet of the communication orifice, the measuring means being able to measure the leakage rate of the communication orifice, in the closed position, at the outlet, outside the mask.

14. The device according to claim 10, wherein the communication orifice is an exhalation valve.

15. The device according to claim 10, wherein the means for generating a pressure differential is an electric pump.

16. The device according to claim 10, wherein the measuring means include a flow meter.

17. The device according to claim 10, wherein the measuring means include a differential pressure gauge.

18. The device according to claim 10, wherein a piston is mounted sliding on the body, a spring being compressed between the body and the piston.

19. The device according to claim 10, wherein the body includes a lip, able to cooperate with a slot provided in the holder.

20. The device according to claim 18, wherein the body includes a lip, able to cooperate with a slot provided in the holder.

21. The device according to claim 18, wherein the piston includes a channel connected to the pressure differential generating means.
